(19) United States
(12) Patent Application Publication
(10) Pub. No.: US 2026/0169364 A1
(43) Pub. Date: Jun. 18, 2026

(54) PROJECTOR AND METHOD OF CONTROLLING TEMPERATURE OF PROJECTOR

(71) Applicant: Coretronic Corporation, Hsin-Chu (TW)

(72) Inventors: Qiu-Jun LIN, Hsin-Chu (TW); Yao-Lei HUANG, Hsin-Chu (TW); Fu-Shan WANG, Hsin-Chu (TW)

(21) Appl. No.: 19/399,647

(22) Filed: Nov. 25, 2025

(30) Foreign Application Priority Data
Dec. 12, 2024 (CN) 2024118248698

(51) Int. Cl. G03B 21/16

(52) U.S. Cl. CPC G03B 21/16

(57) ABSTRACT

A projector is provided. The projector includes at least one heat source, a TEC chip, a driving circuit and a microcontroller. The at least one heat source is adapted to operate in a first mode and to shut down in a second mode. The TEC chip has a first end part and a second end part. The driving circuit is adapted to drive the TEC chip. The microcontroller controls the driving circuit to operate in a first working mode according to the first mode command corresponding to the first mode, and the second end part serves as a cold end to cool the at least one heat source. The microcontroller controls the driving circuit to operate in a second working mode according to the second mode command corresponding to the second mode, and the second end part serves as a hot end to heat.

### CROSS REFERENCE TO RELATED APPLICATION

This application claims the priority benefit of Chinese Patent Application Serial Number 202411824869.8, filed on 12, Dec., 2024, the full disclosure of which is incorporated herein by reference.

### BACKGROUND

### Technical Field

The present disclosure is related to a projector and a method of controlling a temperature of a projector.

### Related Art

A projector is an optical engine device which projects an image onto a wall or a projector screen; specifically, the projector includes a light source, a light valve, a lens and a heat dissipation module. The light source generates an illumination beam, the light valve receives the illumination beam from the light source and converts the illumination beam to an image beam, and then, the image beam is projected on the wall or the projector screen by the lens. Both the light source and the light valve generate heat during operation, and the heat dissipation module guides the heat to the outside of the projector by heat conduction or heat convection to achieve the effects of heat dissipation.

As technology develops, user requirements on the high brightness and the high image quality of the projector daily grows, and the heat generated by the light source and the light valve significantly increases so that the heat dissipation module has difficulty in handling the excessive heat from the light source and the light valve. Hence, one solution to the foregoing problem is to arrange a thermoelectric cooler chip (TEC chip) in the interior of the projector. However, when the temperature on the cold surface of the TEC chip is too low, e.g., when the cold surface of the TEC is situated at the extremely low temperature under the circumstance that the heat source stops working, moisture in the atmosphere of the interior of the projector condenses into dew, and it results in a problem of generating stagnant water on the interior of the projector. Given that the temperature on the cold surface of the TEC chip is not low enough during the operation of the heat source, it is difficult to achieve the purpose of the effective heat dissipation on the projector.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The projector in one embodiment of the present disclosure includes at least one heat source, a TEC chip, a driving circuit and a microcontroller. The at least one heat source is adapted to operate in a first mode and to shut down in a second mode. The TEC chip has a first end part and a second end part, and the second end part is adapted to cool the at least one heat source or to heat. The driving circuit is coupled to the first end part and is adapted to drive the TEC chip. The microcontroller is coupled to the driving circuit. The microcontroller controls the driving circuit to operate in a first working mode according to the first mode command corresponding to the first mode, and controls the driving circuit to operate in a second working mode according to the second mode command corresponding to the second mode. When the driving circuit operates in the first working mode, the first end part serves as a hot end and the second end part serves as a cold end to cool the at least one heat source; when the driving circuit operates in the second working mode, the first end part serves as the cold end and the second end part serves as the hot end to heat.

The method of controlling the temperature of the projector in one embodiment of the present disclosure is for the projector. The projector includes the at least one heat source, the TEC chip, the driving circuit and the microcontroller, and the at least one heat source is adapted to operate in the first mode and to shut down in the second mode. The method of controlling the temperature of the projector includes: in response to the first mode command corresponding to the first mode, controlling the driving circuit to operate in the first working mode by the microcontroller so that the driving circuit outputs a first driving current to the TEC chip by a first current path, and the TEC chip is driven according to the first driving current so that an end part of the TEC chip cools the at least one heat source; in response to the second mode command corresponding to the second mode, controlling the driving circuit to operate in the second working mode by the microcontroller so that the driving circuit is switched to a second current path and outputs a second driving current to the TEC chip by the second current path, and the TEC chip is driven according to the second driving current so that the end part of the TEC chip heats.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A depicts a block diagram of a projector according to one embodiment of the present disclosure.

FIG. 1B depicts a configuration diagram of a TEC chip according to one embodiment of the present disclosure.

FIG. 2 depicts a circuit diagram of a driving circuit according to one embodiment of the present disclosure.

FIG. 3 depicts a flowchart of a method of controlling a temperature of a projector in response to a first mode command according to one embodiment of the present disclosure.

FIG. 4 depicts the schematic diagram of the driving circuit shown in FIG. 2 in a first working mode.

FIG. 5 depicts the flowchart of the method of controlling the temperature of the projector in response to a second mode command according to one embodiment of the present disclosure.

FIG. 6 depicts the schematic diagram of the driving circuit shown in FIG. 2 in a second working mode.

FIG. 7 depicts a flowchart of a method of controlling a temperature of a projector in response to the second mode command according to another embodiment of the present disclosure.

FIG. 8A depicts a circuit diagram of a driving circuit according to another embodiment of the present disclosure.

FIG. 8B depicts the configuration diagram of the relay shown in FIG. 8A.

FIG. 9 depicts the schematic diagram of the driving circuit shown in FIG. 8A in the first working mode.

FIG. 10A depicts the configuration diagram of the relay shown in FIG. 8A in the second working mode.

FIG. 10B depicts the schematic diagram of the driving circuit shown in FIG. 8A in the second working mode.

### DETAILED DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

In light of the aforementioned description, the present disclosure provides a projector and a method of controlling a temperature of a projector to solve the problem of generating the stagnant water in the interior of the projector.

In order to achieve one, one part or all of the objectives, the present disclosure provides a projector including at least one heat source, a TEC chip, a driving circuit and a microcontroller. The at least one heat source is adapted to operate in a first mode and to shut down in a second mode. The TEC chip has a first end part and a second end part, and the second end part is adapted to cool the at least one heat source or to heat. The driving circuit is coupled to the first end part and is adapted to drive the TEC chip. The microcontroller is coupled to the driving circuit. The microcontroller controls the driving circuit to operate in a first working mode according to the first mode command corresponding to the first mode, and controls the driving circuit to operate in a second working mode according to the second mode command corresponding to the second mode. When the driving circuit operates in the first working mode, the first end part serves as a hot end and the second end part serves as a cold end to cool the at least one heat source; when the driving circuit operates in the second working mode, the first end part serves as the cold end and the second end part serves as the hot end to heat.

The present disclosure additionally provides a method of controlling a temperature of a projector for the aforementioned projector. The method of controlling the temperature of the projector includes: in response to the first mode command corresponding to the first mode, controlling the driving circuit to operate in the first working mode by the microcontroller so that the driving circuit outputs a first driving current to the TEC chip by a first current path, and the TEC chip is driven according to the first driving current so that an end part of the TEC chip cools the at least one heat source; in response to the second mode command corresponding to the second mode, controlling the driving circuit to operate in the second working mode by the microcontroller so that the driving circuit is switched to a second current path and outputs a second driving current to the TEC chip by the second current path, and the TEC chip is driven according to the second driving current so that the end part of the TEC chip heats.

Hence, the projector and the method of controlling the temperature of the projector may select to cool the heat source or heat the end part of the TEC chip that facing the heat source according to whether the state of the heat source operates in the first mode or the second mode to implement the function of the heat dissipation and solve the problem of the stagnant water in the interior of the projector.

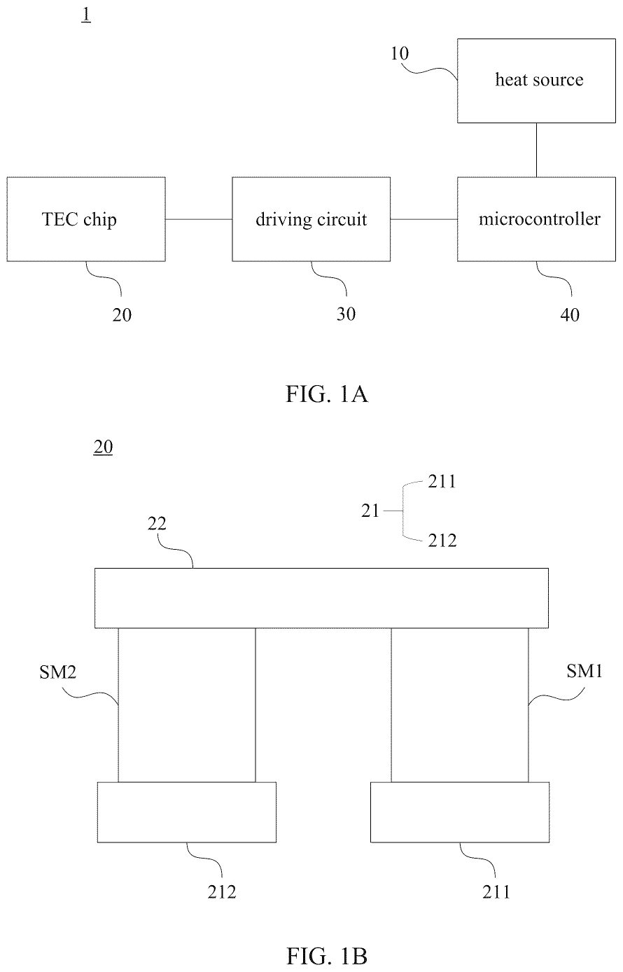

Please refer to FIG. 1A, which depicts a block diagram of a projector according to one embodiment of the present disclosure. As shown in FIG. 1, a projector 1 include at least one heat source 10, a TEC chip 20, a driving circuit 30 and a microcontroller 40. The at least one heat source 10, the TEC chip 20, the driving circuit 30 and the microcontroller 40 are all located in the interior of the projector 1. It should be noted that the TEC chip 20 may perform heat dissipation from one or more heat sources of the projector 1; therefore, the number of the heat source 10 may be one or plural and may not be limited thereto.

The heat source 10 is adapted to operate in a first mode and to shut down in a second mode. The at least one heat source 10 may be a light source module and/or a light valve module; for example, the light source module may be constituted by a plurality of light-emitting diodes (LEDs) or a plurality of laser diodes (LDs) and may not be limited thereto, and for example, the light valve module may be a digital micromirror device (DMD) or a liquid crystal on silicon (LCoS) display and may not be limited thereto. The first mode is the power up mode of the projector 1, and the second mode includes at least one of the shutdown mode and the standby mode of the projector 1. Specifically, the heat source 10 is adapted to operate in the power up mode and to shut down in the shutdown mode and the standby mode.

In one embodiment, the number of the heat source 10 is one, and the heat source 10 may be the light source module, for example. In the power up mode, the light source module emits an illumination beam according to image information; in the shutdown mode and the standby mode, the light source module does not emit light. In another embodiment, the number of the heat sources 10 is plural and may include the light source module and the light valve module, for example. In the power up mode, the light source module emits the illumination beam according to the image information, the light valve module converts the illumination beam to an image beam; in the shutdown mode and the standby mode, the light source module does not emit light, and the light valve module does not work.

The end part of the TEC chip 20 is adapted to cool the at least one heat source 10 to exhaust the heat of the at least one heat source 10 to the exterior of the projector 1, and is adapted to heat the dew (i.e., condensation water) generated by the end part of the TEC chip 20 during a cooling process to evaporate the dew. Please further refer to FIG. 1B, which depicts a configuration diagram of a TEC chip according to one embodiment of the present disclosure. As shown in FIG. 1B, the TEC chip 20 has a first end part 21 and a second end part 22 which are oppositely disposed. In conjunction with FIG. 1A, the first end part 21 is connected to the driving circuit 30 by a plurality of conductive wires. Specifically, the first end part 21 includes a first electrical connection terminal 211 and a second electrical connection terminal 212. The second end part 22 is closer to the at least one heat source 10 than the first end part 21, or the second end part 22 is thermally connected (inclusive of direct connection and indirect connection) to the at least one heat source 10. The materials of the first electrical connection terminal 211, the second electrical connection terminal 212 and the second end part 22 are all metal materials, and the metal materials include In, Sn, Al, Au, Pt, Zn, Ge, Ag, Pb, Pd, Cu, AuBe, BeGe, Ni, PbSn, Cr, AuZn, Ti, W, TiW or the alloy or the compound of the aforementioned metals.

The TEC chip 20 further includes a plurality of first semiconductors SM1 and a plurality of second semiconductors SM2. The conductivity type of each first semiconductor SM1 is a first conductivity type, and the conductivity type of each second semiconductor SM2 is a second conductivity type opposite to the first conductivity type; for example, the first conductivity type is N-type, and the second conductivity type is P-type. For convenience of explanation, FIG. 1B shows one first semiconductor SM1 and one second semiconductor SM2, and the first semiconductor SM1 and the second semiconductor SM2 are respectively connected to the first electrical connection terminal 211 and the second electrical connection terminal 212, but the configuration shown in FIG. 1B is exemplary and is not used to limit the number of the first semiconductors SM1 and the number of the second semiconductors SM2.

The driving circuit 30 is coupled to the first end part 21 and is adapted to drive the TEC chip 20. Specifically, the driving circuit 30 is coupled to the first electrical connection terminal 211 and the second electrical connection terminal 212, and transmits a driving current to drive the TEC chip 20. By transmitting the driving current to the first electrical connection terminal 211 and the second electrical connection terminal 212, the first end part 21 serves as one of a cold end and a hot end, and the second end part 22 serves as the other of the cold end and the hot end; in other words, according to the current direction of the driving current between the first electrical connection terminal 211 and the second electrical connection terminal 212, the first end part 21 serves as one of the cold end and the hot end, and the second end part 22 serves as the other of the cold end and the hot end. In the first mode, the current direction between the first electrical connection terminal 211 and the second electrical connection terminal 212 is that the driving current flows out of the second electrical connection terminal 212 after passing from the first electrical connection terminal 211 to the second end part 22; at present, the first end part 21 serves as the hot end, and the second end part 22 serves as the cold end. In the second mode, the current direction between the first electrical connection terminal 211 and the second electrical connection terminal 212 is that the driving current flows out of the first electrical connection terminal 211 after passing from the second electrical connection terminal 212 to the second end part 22; at present, the first end part 21 serves as the cold end, and the second end part 22 serves as the hot end.

The microcontroller 40 is coupled to the driving circuit 30 and the at least one heat source 10, controls the driving circuit 30 to operate in a first working mode or a second working mode to switch the current path of the driving circuit 30, and controls the operation and the shutdown of the at least one heat source 10. In one embodiment, the microcontroller 40 is wirelessly coupled to an external electronic device by the wireless transceiver of the projector 1 to receive the first mode command corresponding to the first mode and the second mode command corresponding to the second mode, or directly receives the first mode command corresponding to the first mode and the second mode command corresponding to the second mode by the user interface of the projector 1. The first mode command and the second mode command, for example, are generated by user manipulation, therein the first mode command is a power up signal, the second mode command is at least one of a shutdown signal and a standby signal, and the external electronic device is a remote controller or a set of a keyboard and a mouse. In another embodiment, the microcontroller 40 receive the first mode command corresponding to the first mode and the second mode command corresponding to the second mode from the internet by the wireless transceiver of the projector 1.

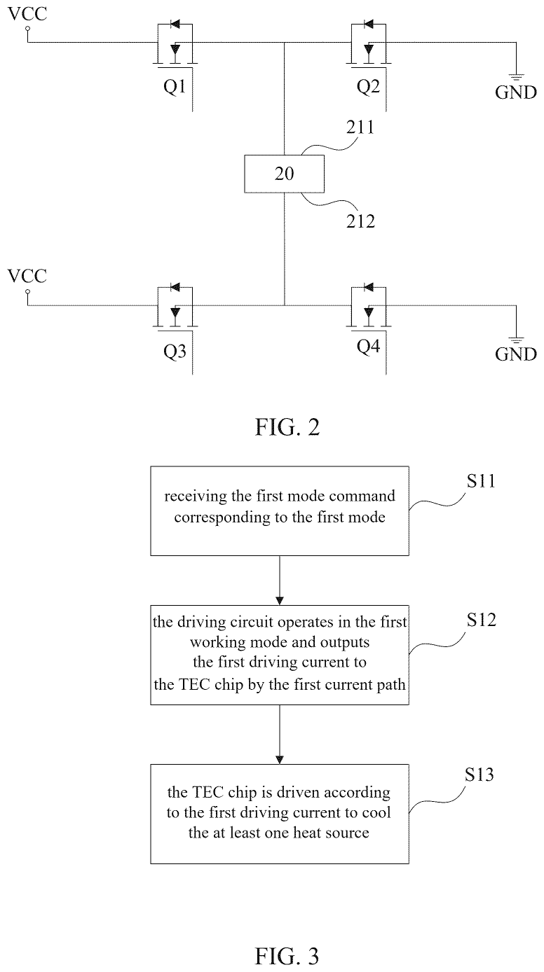

Please refer to FIG. 2, which depicts a circuit diagram of a driving circuit according to one embodied aspect of the present disclosure. As shown in FIG. 2, in one embodiment, the driving circuit 30 is a H-bridge circuit. Specifically, the driving circuit 30 includes a first switch component Q1, a second switch component Q2, a third switch component Q3 and a fourth switch component Q4. The first switch component Q1 is coupled between a power supply terminal VCC and the first electrical connection terminal 211 of the TEC chip 20. The second switch component Q2 is coupled between a ground terminal GND and the first electrical connection terminal 211 of the TEC chip 20, and is serially connected to the first switch component Q1. The third switch component Q3 is coupled between the power supply terminal VCC and the second electrical connection terminal 212 of the TEC chip 20. The fourth switch component Q4 is coupled between the ground terminal GND and the second electrical connection terminal 212 of the TEC chip 20, and is serially connected to the third switch component Q3. In other words, the TEC chip 20 is located between the first switch component Q1 and the fourth switch component Q4, and is situated between the third switch component Q3 and the second switch component Q2. The power supply terminal VCC is connected to the power module of the projector 1.

The first switch component Q1, the second switch component Q2, the third switch component Q3 and the fourth switch component Q4 may be metal-oxide-semiconductor field-effect transistors (MOSFETs) or junction field-effect transistors (JFETs), and the aforementioned descriptions are exemplary and are not used to limit the present disclosure. In the present embodiment, the first switch component Q1 to the fourth switch component Q4 are all the N-type MOSFETs. In the other embodiment, the first switch component Q1 and the fourth switch component Q4 may be the N-type MOSFETs, and the second switch component Q2 and the third switch component Q3 may be the P-type MOSFETs. However, the first switch component Q1 to the fourth switch component Q4 are not limited thereto, and the switch types of the first switch component Q1 to the fourth switch component Q4 may change dependent upon requirements.

In the present embodiment, as shown in FIG. 1A and FIG. 2, the first switch component Q1, the second switch component Q2, the third switch component Q3 and the fourth switch component Q4 are respectively coupled to the microcontroller 40, and the microcontroller 40 is configured to control the on-state of each of the first switch component Q1 to the fourth switch component Q4. Specifically, the gate of the first switch component Q1, the gate of the second switch component Q2, the gate of the third switch component Q3 and the gate of the fourth switch component Q4 are respectively coupled to the microcontroller 40 by a general-purpose input/output (GPIO). The microcontroller 40 controls the on-time of the first switch component Q1 to be the same as the on-time of the fourth switch component Q4 and controls the on-time of the second switch component Q2 to be the same as the on-time of the third switch component Q3. In other words, the off-time of the first switch component Q1 is the same as the off-time of the fourth switch component Q4, and the off-time of the second switch component Q2 is the same as the off-time of the third switch component Q3.

FIG. 3 depicts a flowchart of a method of controlling a temperature of a projector in response to a first mode command according to one embodiment of the present disclosure. Step S11: receiving the first mode command corresponding to the first mode. As described above, the microcontroller 40 may receive the first mode command corresponding to the power up mode which is generated by the user manipulation. At present, the microcontroller 40 controls the at least one heat source 10 (e.g., the light source) to operate in the power up mode.

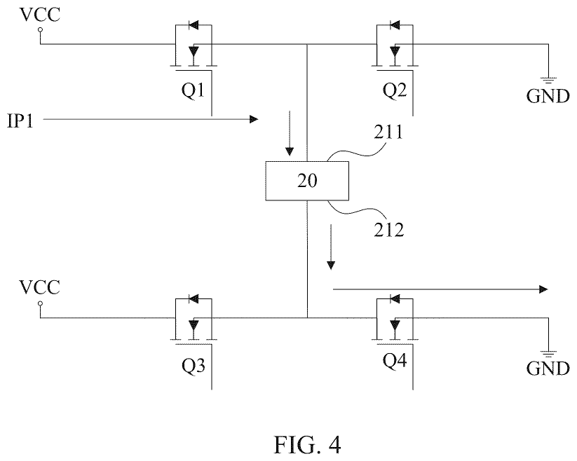

Please refer to FIG. 3 and FIG. 4 together, and FIG. 4 depicts the schematic diagram of the driving circuit shown in FIG. 2 in a first working mode. In response to the first mode command, in step S12, the driving circuit 30 operates in the first working mode and outputs a first driving current to the TEC chip 20 by a first current path IP1. Specifically, the microcontroller 40 generates and transmits a first control signal to the driving circuit 30 so that the driving circuit 30 operates in the first working mode. The driving circuit 30 is switched to the first current path IP1 according to the first control signal. At present, the first switch component Q1 and the fourth switch component Q4 are switched to a conductive state according to the first control signal, and the second switch component Q2 and the third switch component Q3 are switched to a non-conductive state according to the first control signal to switch the driving circuit 30 to the first current path IP1. The driving circuit 30 outputs the first driving current to the TEC chip 20 by the first current path IP1. The travelling path of the first driving current on the first current path IP1 is elaborated as follows: the first driving current flows from the first switch component Q1 into the first electrical connection terminal 211 of the TEC chip 20 and outputs from the second electrical connection terminal 212 of the TEC chip 20; afterwards, the first driving current outputting from the second electrical connection terminal 212 of the TEC chip 20 passes through the fourth switch component Q4.

After the first driving current is outputted by the first switch component Q1 and flows into the TEC chip 20, in step S13, the TEC chip 20 is driven according to the first driving current; at present, the first end part 21 serves as the hot end, and the second end part 22 serves as the cold end and cools down to cool the at least one heat source 10.

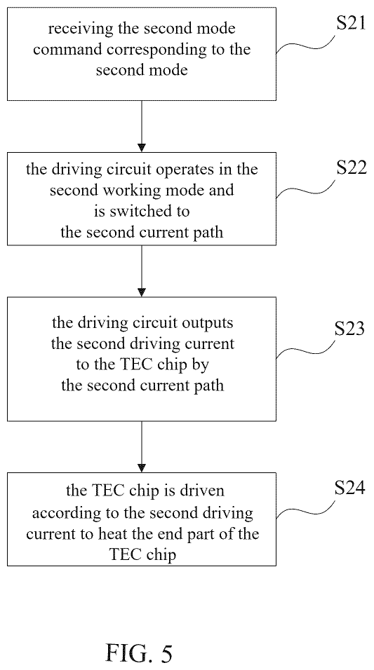

FIG. 5 depicts the flowchart of the method of controlling the temperature of the projector in response to a second mode command according to one embodiment of the present disclosure. Step S21: receiving the second mode command corresponding to the second mode. As described above, the microcontroller 40 may receive the second mode command corresponding to the shutdown mode or the standby mode which is generated by the user manipulation. At present, the microcontroller 40 controls the at least one heat source 10 (e.g., the light source) to shut down in the shutdown mode or the standby mode.

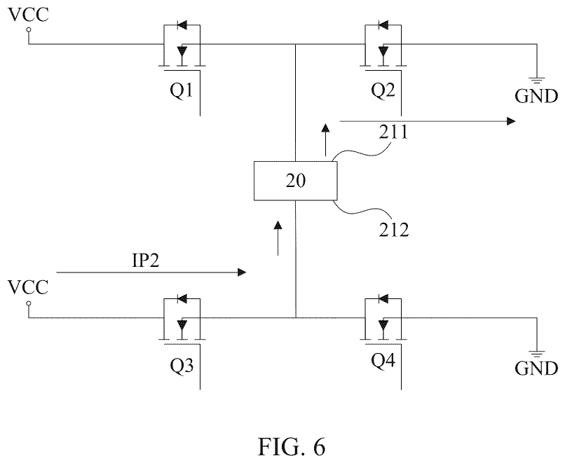

Please refer to FIG. 5 and FIG. 6 together, and FIG. 6 depicts the schematic diagram of the driving circuit shown in FIG. 2 in a second working mode. In response to the second mode command, in step S22, the driving circuit 30 operates in the second working mode and is switched to the second current path IP2. Specifically, the microcontroller 40 generates and transmits a second control signal to the driving circuit 30 so that the driving circuit 30 operates in the second working mode. The driving circuit 30 is switched to the second current path IP2 according to the second control signal. At present, the first switch component Q1 and the fourth switch component Q4 are switched to the non-conductive state according to the second control signal, and the second switch component Q2 and the third switch component Q3 are switched to the conductive state according to the second control signal to switch the driving circuit 30 to the second current path IP2.

In step S23, the driving circuit 30 outputs the second driving current to the TEC chip 20 by the second current path IP2. At present, the travelling path of the second driving current on the second current path IP2 is elaborated as follows: the second driving current flows from the third switch component Q3 into the second electrical connection terminal 212 of the TEC chip 20 and outputs from the first electrical connection terminal 211 of the TEC chip 20; afterwards, the second driving current outputting from the second electrical connection terminal 212 of the TEC chip 20 passes through the second switch component Q2.

After the second driving current is outputted by the third switch component Q3 and flows into the TEC chip 20, in step S24, the TEC chip 20 is driven according to the second driving current; at present, the first end part 21 serves as the cold end, and the second end part 22 serves as the hot end and heats to evaporate the dew of the second end part 22.

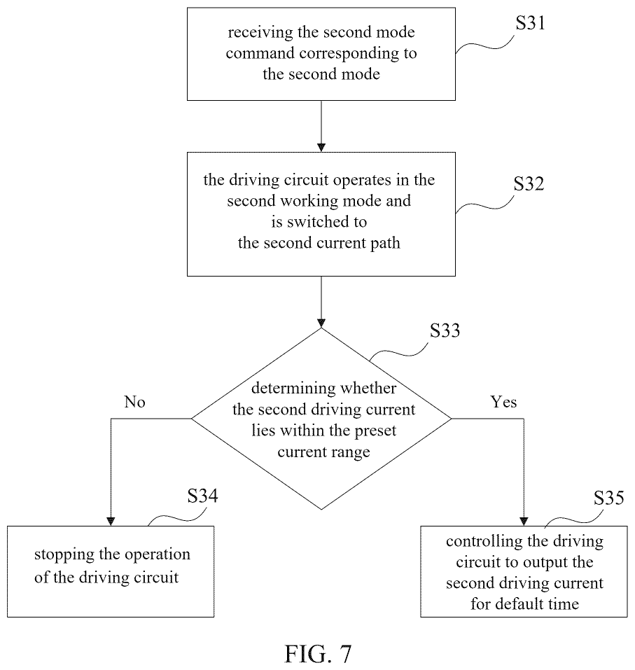

Please refer to FIG. 7, which depicts a flowchart of a method of controlling a temperature of a projector in response to the second mode command according to another embodiment of the present disclosure. As shown in FIG. 7, the steps in the method of controlling the temperature of the projector which are performed in response to the second mode includes step S31 to step S35; therein step S31 and step S32 are the same as step S21 and step S22 shown in FIG. 5 and would not be repeated.

Step S33: determining whether the second driving current lies within a preset current range. Specifically, the microcontroller 40 stores the preset current range and is able to determine whether to continue the operation of the driving circuit 30 according to the second driving current and the preset current range. When determining that the second driving current does not lie within the preset current range, the microcontroller 40 subsequently performs step S34: stopping the operation of the driving circuit 30; when determining that the second driving current lies within the preset current range, the microcontroller 40 subsequently performs step S35.

Step S35: controlling the driving circuit 30 to output the second driving current for default time. Specifically, the second control signal transmitted from the microcontroller 40 to the driving circuit 30 includes driving time information, and the driving circuit 30 continues to output the second driving current for the default time according to the driving time information so that the TEC chip 20 rises the temperature of the second end part 22 according to the second driving current. The driving circuit 30 further stops the operation of the driving circuit 30 after operation time of the driving circuit 30 exceeds t the default time.

It should be noted that the preset current range is associated with the temperature rise of the second end part 22. By setting the preset current range, the temperature of the second end part 22 is controlled during the temperature rise and would not exceed a preset temperature (e.g., 50° C.) to prevent the temperature of the second end part 22 from being so high that the interior of the projector overheats to result in damage to the component. The method of controlling the temperature of the projector in the present embodiment determines whether the second driving current is excessively high by comparing the second driving current with the preset current range to control the temperature of the second end part 22 to lie within the preset temperature.

In addition, the default time is also associated with the temperature rise of the second end part 22. By setting the default time, the time of the temperature rise (e.g., higher than the environment temperature of the projector 1) of the second end part 22 is controlled to be not too long to prevent the second end part 22 from continuously lying on the higher temperature, therein the interior of the projector overheats to result in damage to the component.

In one embodiment, the projector 1 may further include a fan, and the operation of the fan is beneficial for air circulation in the interior of the projector 1. When the driving circuit 30 operates in the second working mode, the fan of the projector 1 operate at the same time. In another embodiment, when the driving circuit 30 operates in the second working mode, the fan of the projector 1 may be turned off.

In one embodiment, the projector 1 may further include a temperature sensor. The temperature sensor is coupled to the microcontroller 40 and is disposed adjacent to the second end part 22 of the TEC chip 20. The temperature sensor is adapted to sense the ambient temperature of the second end part 22 and transmits the sensed temperature signal to the microcontroller 40. Thus, by monitoring the variations of the ambient temperature of the second end part 22, the purpose of controlling the ambient temperature of the second end part 22 effectively may be further achieved.

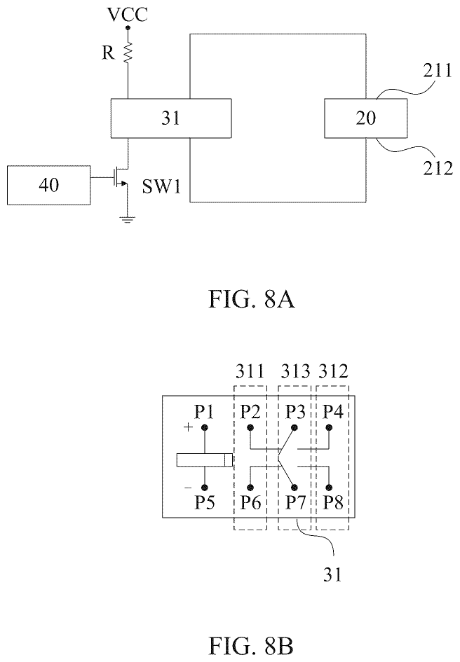

Please refer to FIG. 8A and FIG. 8B, which depict a circuit diagram of a driving circuit according to another embodiment of the present disclosure and the configuration diagram of the relay shown in FIG. 8A. In the present embodiment, the driving circuit 30 includes a switch component SW1, a relay 31 and a resistance R. The switch component SW1 is coupled to the microcontroller 40 and the ground terminal GND; the switch component SW1 may be the MOSFET or the JFET, and the aforementioned descriptions are exemplary and are not used to limit the present disclosure. The relay 31 is coupled to the switch component SW1, the first electrical connection terminal 211 and the second electrical connection terminal 212 of the TEC chip 20. The relay 31 includes a first pair of power supply connection terminals 311, a second pair of power supply connection terminals 312 and a switching part 313. The switching part 313 is coupled to the first electrical connection terminal 211 and the second electrical connection terminal 212 of the TEC chip 20 and is selectively switched to be connected to the first pair of power supply connection terminals 311 or the second pair of power supply connection terminals 312. The resistance R is coupled to the power supply terminal VCC and the relay 31. Furthermore, the relay 31 includes pins P1˜P8. The pin P1 is coupled to the resistance R. The pin P5 is coupled to the switch component SW1. The pins P2 and P6 serve as the first pair of power supply connection terminals 311 and are adapted to receive a first supply voltage. The pins P4 and P8 serve as the second pair of power supply connection terminals 312 and are adapted to receive a second supply voltage. The pins P3 and P7 serve as the switching part 313, therein the pin P3 is coupled to the first electrical connection terminal 211 of the TEC chip 20, and the pin P7 is coupled to the second electrical connection terminal 212 of the TEC chip 20. The aforementioned pin connection of the relay 31 and the aforementioned connection of the switching part 313 and the TEC chip 20 are exemplary and are not used to limit the present disclosure, and persons skilled in the art may change the aforementioned pin connection of the relay 31 and the aforementioned connection of the switching part 313 and the TEC chip 20 according to requirements.

In the present embodiment, the contacts between the switching part 313 and the first pair of power supply connection terminals 311 of the relay 31 are normally closed (NC) contacts (i.e., the conductive state), and the contacts between the switching part 313 and the second pair of power supply connection terminals 312 are normally open (NO) contacts (i.e., the non-conductive state). The microcontroller 40 is connected to the switch component SW1 and controls the conductive state of the switch component SW1. Specifically, the microcontroller 40 may generate and transmit a control signal to the switch component SW1 to switch the switch component SW1 to the conductive state, and the control signal is transmitted from the switch component SW1 to the relay 31. The switching part 313 is disconnected from the first pair of power supply connection terminals 311 by the trigger of the control signal and changes to be connected to the second pair of power supply connection terminals 312.

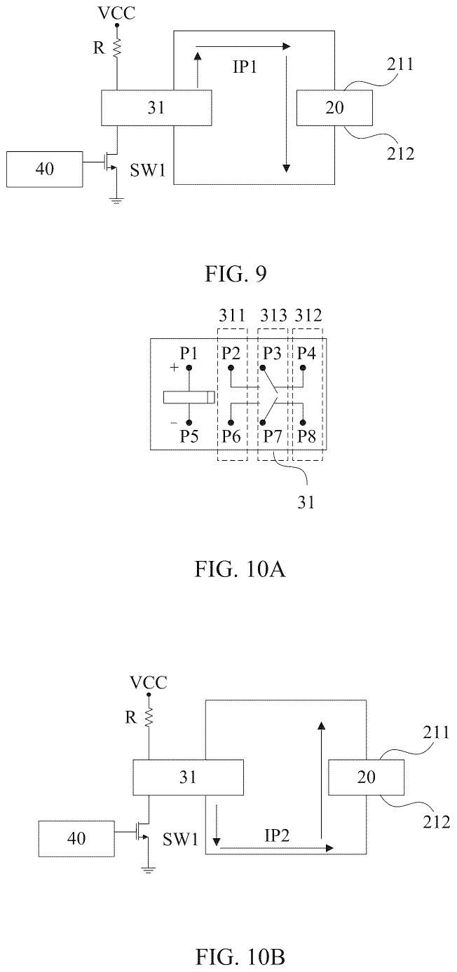

Please refer to FIG. 3, FIG. 8B and FIG. 9 together, and FIG. 9 depicts the schematic diagram of the driving circuit shown in FIG. 8A in the first working mode. In response to the first mode command, the microcontroller 40 does not output the control signal to the switch component SW1, the driving circuit 30 operates in the first working mode, and the pin P1 merely receives the voltage and the current from the power supply terminal VCC; therefore, the electrical potential difference between the pin P1 and the pin P5 of the relay 31 is not greater than the rated voltage of the relay 31, and the switching part 313 would not be triggered. Because the contacts between the switching part 313 and the first pair of power supply connection terminals 311 of the relay 31 are NC contacts and the switching part 313 is not triggered, the switching part 313 still remains connected to the first pair of power supply connection terminals 311. The relay 31 receives the first supply voltage from the first pair of power supply connection terminals 311 and outputs the first driving current from the pin P3 to the TEC chip 20 according to the first supply voltage so that the first driving current flows along the first current path IP1. The travelling path of the first driving current on the first current path IP1 is elaborated as follows: the pin P2 is the starting point of the first driving current, the first driving current flows from the pin P2 into the pin P3, and the first driving current outputting from the pin P3 flows into the first electrical connection terminal 211 of the TEC chip 20 and flows out of the second electrical connection terminal 212 of the TEC chip 20; afterwards, the first driving current outputting from the second electrical connection terminal 212 of the TEC chip 20 passes through the pin P7 and flows into the pin P6, and the pin P6 is the endpoint of the first driving current. The TEC chip 20 is driven according to the first driving current, and at present, the first end part 21 serves as the hot end, and the second end part 22 serves as the cold end and cools down to cool the at least one heat source 10.

Please refer to FIG. 5, FIG. 10A and FIG. 10B together. FIG. 10A depicts the configuration diagram of the relay shown in FIG. 8A in the second working mode, and FIG. 10B depicts the schematic diagram of the driving circuit shown in FIG. 8A in the second working mode. In response to the second mode command, the microcontroller 40 generates and transmits the control signal to the driving circuit 30 to control the driving circuit 30 operate in the second working mode, and the driving circuit 30 is switched to the second current path IP2 according to the control signal. Specifically, the microcontroller 40 generates and transmits the control signal to the switch component SW1 so that the switch component SW1 is switched to the conductive state. At present, the pin P1 receives the voltage and the current from the power supply terminal VCC, and the pin P5 receives the control signal from the switch component SW1; therefore, the electrical potential difference between the pin P1 and the pin P5 of the relay 31 is greater than the rated voltage of the relay 31, and the switching part 313 is triggered to be disconnected from the first pair of power supply connection terminals 311 and changes to be connected to the second pair of power supply connection terminals 312. The relay 31 receives the second supply voltage from the second pair of power supply connection terminals 312 and outputs the second driving current from the pin P7 to the TEC chip 20 according to the second supply voltage so that the second driving current flows along the second current path IP2. The travelling path of the second driving current on the second current path IP2 is elaborated as follows: the pin P8 is the starting point of the second driving current, the second driving current flows from the pin P8 into the pin P7, and the second driving current outputting from the pin P7 flows into the second electrical connection terminal 212 of the TEC chip 20 and flows out of the first electrical connection terminal 211 of the TEC chip 20; afterwards, the second driving current outputting from the first electrical connection terminal 211 of the TEC chip 20 passes through the pin P3 and flows into the pin P4, and the pin P4 is the endpoint of the second driving current. The TEC chip 20 is driven according to the second driving current, and at present, the first end part 21 serves as the cold end, and the second end part 22 serves as the hot end and heats to evaporate the dew of the second end part 22. In the present embodiment, the flowing direction of the first driving current in the TEC chip 20 is different from the flowing direction of the second driving current in the TEC chip 20.

In one embodiment, the power module of the projector 1 may be respectively coupled to the first pair of power supply connection terminals 311 and the second pair of power supply connection terminals 312 to provide the first supply voltage and the second supply voltage to the relay 31. The microcontroller 40 may be further coupled to the power module to control the value of the first supply voltage and the second supply voltage and thus control the value of the first driving current and the second driving current.

In view of the above description, the projector and the method of controlling the temperature of the projector controls the driving circuit to drive an end part of the TEC chip to cool down according to the operation of the heat source to cool the heat source, thereby achieving the purpose of the heat dissipation. The projector and the method of controlling the temperature of the projector controls the driving circuit to drive the end part of the TEC chip to heat according to the shutdown of the heat source to evaporate the dew generated by the end part of the TEC chip when the end part of the TEC chip serves as the cold end, thereby avoiding the interior of the projector from generating the stagnant water.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of . . . and . . . ” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projector comprising:
at least one heat source adapted to operate in a first mode and to shut down in a second mode;
a TEC chip provided with a first end part and a second end part, wherein the second end part is adapted to cool the at least one heat source or to heat;
a driving circuit coupled to the first end part and adapted to drive the TEC chip; and
a microcontroller coupled to the driving circuit, controlling the driving circuit to operate in a first working mode according to a first mode command corresponding to the first mode, and controlling the driving circuit to operate in a second working mode according to a second mode command corresponding to the second mode;
wherein the first end part serves as a hot end and the second end part serves as a cold end to cool the at least one heat source when the driving circuit operates in the first working mode; the first end part serves as the cold end and the second end part serves as the hot end to heat when the driving circuit operates in the second working mode.

2. The projector according to claim 1, wherein the microcontroller generates and transmits a first control signal to the driving circuit in response to the first mode command, the driving circuit is switched to a first current path according to the first control signal and outputs a first driving current to the TEC chip by the first current path, and the TEC chip is driven according to the first driving current so that the second end part cools the at least one heat source;
the microcontroller generates and transmits a second control signal to the driving circuit in response to the second mode command, the driving circuit is switched to a second current path according to the second control signal and outputs a second driving current to the TEC chip by the second current path, and the TEC chip is driven according to the second driving current so that the second end part heats.

3. The projector according to claim 2, wherein the microcontroller determines whether the second driving current lies within a preset current range; the microcontroller stops operation of the driving circuit when determining that the second driving current does not lie within the preset current range, whereas the microcontroller controls the driving circuit to output the second driving current for default time when determining that the second driving current lies within the preset current range.

4. The projector according to claim 2, wherein the second control signal comprises driving time information, and the driving circuit outputs the second driving current for default time according to the driving time information and stops operation of the driving circuit after operation time of the driving circuit exceeds the default time.

5. The projector according to claim 1, wherein the first end part of the TEC chip comprises a first electrical connection terminal and a second electrical connection terminal, and the driving circuit comprises:
a first switch component coupled between a power supply terminal and the first electrical connection terminal of the TEC chip;
a second switch component coupled between a ground terminal and the first electrical connection terminal of the TEC chip and serially connected to the first switch component;
a third switch component coupled between the power supply terminal and the second electrical connection terminal of the TEC chip; and
a fourth switch component coupled between the ground terminal and the second electrical connection terminal of the TEC chip and serially connected to the third switch component;
wherein the first switch component, the second switch component, the third switch component and the fourth switch component are respectively coupled to the microcontroller.

6. The projector according to claim 5, wherein the microcontroller generates and transmits a first control signal to the driving circuit in response to the first mode command so that the driving circuit operates in the first working mode, the first switch component and the fourth switch component are switched to a conductive state according to the first control signal, the second switch component and the third switch component are switched to a non-conductive state according to the first control signal, the first switch component outputs a first driving current to the TEC chip, and the TEC chip is driven according to the first driving current so that the second end part cools the at least one heat source.

7. The projector according to claim 5, wherein the microcontroller generates and transmits a second control signal to the driving circuit in response to the second mode command so that the driving circuit operates in the second working mode, the first switch component and the fourth switch component are switched to a non-conductive state according to the second control signal, the second switch component and the third switch component are switched to a conductive state according to the second control signal, the third switch component outputs a second driving current to the TEC chip, and the TEC chip is driven according to the second driving current so that the second end part heats.

8. The projector according to claim 1, wherein the first end part of the TEC chip comprises a first electrical connection terminal and a second electrical connection terminal, and the driving circuit comprises:
a switch component coupled to the microcontroller and a ground terminal;
a relay coupled the switch component, the first electrical connection terminal and the second electrical connection terminal and the relay comprising a first pair of power supply connection terminals, a second pair of power supply connection terminals and a switching part, wherein the switching part is coupled to the first electrical connection terminal and the second electrical connection terminal of the TEC chip and is selectively switched to be connected to the first pair of power supply connection terminals or the second pair of power supply connection terminals; and
a resistance coupled to a power supply terminal and the relay.

9. The projector according to claim 8, wherein the switching part is connected to the first pair of power supply connection terminals when the driving circuit operates in the first working mode, the first pair of power supply connection terminals receive a first supply voltage, the relay outputs a first driving current to the TEC chip according to the first supply voltage, and the TEC chip is driven according to the first driving current so that the second end part cools the at least one heat source; and
the switching part is connected to the second pair of power supply connection terminals when the driving circuit operates in the second working mode, the second pair of power supply connection terminals receive a second supply voltage, the relay outputs a second driving current to the TEC chip according to the second supply voltage, and the TEC chip is driven according to the second driving current so that the second end part heats;
wherein a flowing direction of the first driving current in the TEC chip is different from a flowing direction of the second driving current in the TEC chip.

10. The projector according to claim 8, wherein the microcontroller generates and transmits a control signal to the switch component in response to the second mode command, and the switch component is turned to a conductive state so that the switching part is connected to the second pair of power supply connection terminals.

11. The projector according to claim 1, wherein a fan of the projector operates when the driving circuit operates in the second working mode.

12. The projector according to claim 1, wherein the at least one heat source is a light source module and/or a light valve module.

13. The projector according to claim 1, wherein the first mode is a power up mode, and the second mode comprises at least one of a shutdown mode and a standby mode.

14. A method of controlling a temperature of a projector, for the projector which comprises at least one heat source adapted to operate in a first mode and to shut down in a second mode, a TEC chip, a driving circuit and a microcontroller, comprising:
in response to a first mode command corresponding to the first mode, controlling the driving circuit to operate in a first working mode by the microcontroller so that the driving circuit outputs a first driving current to the TEC chip by a first current path, and the TEC chip is driven according to the first driving current so that an end part of the TEC chip cools the at least one heat source; and
in response to a second mode command corresponding to the second mode, controlling the driving circuit to operate in a second working mode by the microcontroller so that the driving circuit is switched to a second current path and outputs a second driving current to the TEC chip by the second current path, and the TEC chip is driven according to the second driving current so that the end part of the TEC chip heats.

15. The method of controlling the temperature of the projector according to claim 14, further comprising:
in response to the first mode command corresponding to the first mode, generating and transmitting a first control signal to the driving circuit by the microcontroller so that the driving circuit operates in the first working mode and is switched to the first current path according to the first control signal; and
in response to the second mode command corresponding to the second mode, generating and transmitting a second control signal to the driving circuit by the microcontroller so that the driving circuit operates in the second working mode and is switched to the second current path according to the second control signal.

16. The method of controlling the temperature of the projector according to claim 15, further comprising:
determining whether the second driving current lies within a preset current range by the microcontroller;
in response to determine that the second driving current does not lie within the preset current range, stopping operation of the driving circuit by the microcontroller;
in response to determine that the second driving current lies within the preset current range, controlling the driving circuit to output the second driving current for default time by the microcontroller.

17. The method of controlling the temperature of the projector according to claim 15, wherein the second control signal comprises driving time information, and the driving circuit outputs the second driving current for default time according to the driving time information and stops operation of the driving circuit after operation time of the driving circuit exceeds the default time.

18. The method of controlling the temperature of the projector according to claim 14, further comprising:
in response to second mode command corresponding to the second mode, generating and transmitting a control signal to the driving circuit by the microcontroller to control the driving circuit to operate in the second working mode so that the driving circuit is switched to the second current path according to the control signal.
